(19) United States
(12) Patent Application Publication
(10) Pub. No.: US 2015/0294560 A1
(43) Pub. Date: Oct. 15, 2015

(54) REMOTELY CONTROLLABLE ELECTRONIC DEVICE

(71) Applicant: WEI-CHIH HUANG, TAIPEI CITY (TW)

(72) Inventor: WEI-CHIH HUANG, TAIPEI CITY (TW)

(21) Appl. No.: 14/250,443

(22) Filed: Apr. 11, 2014

(51) Int. Cl. G08C 23/04; H04B 10/40

(52) U.S. Cl. CPC G08C 23/04; H04B 10/40

(57) ABSTRACT

A remotely controllable electronic device comprises an infrared receiver, a control unit and a keypad unit. The infrared receiver is for wirelessly receiving a plurality of control signals. The control unit is coupled to the infrared receiver and generates a plurality of function signals. Each function signal is corresponding to one of the control signals received by the infrared receiver. The keypad unit is coupled to the control unit. The keypad unit has a learning mode key. The learning mode key is for making the remotely controllable electronic device operate in a learning mode. The remotely controllable electronic device could be control by the control signals of any infrared remote control.

### BACKGROUND OF THE INVENTION

1. Field of the Invention

The instant disclosure relates to remote control; in particular, to a remotely controllable electronic device.

2. Description of Related Art

The remote control for television is developed in the 1950s. Initially, the remote control is wired to the television. The first wireless remote, introduced in 1955, was called the Flashmatic. The Zenith remote shined highly focused light beams on the receivers located around the screen of the television. At present, many home appliances are able to be controlled by the corresponding remote controls, the fans, or the air conditioners.

Please refer to FIG. 1 showing a block diagram of a conventional remote control system. A remote control system 1 comprises a dedicated remote control 11 and a remotely controllable electronic device 12. The remotely controllable electronic device 12 comprises a power supply 121, a actuating means 122, a control unit 123, a status indicating unit 124 (e.g., LED shown in FIG. 1), keypad 125, an IR receiver 126 and a power plug 127. The IR receiver 126 receives the IR control signal from the dedicated remote control 11, then the control unit 123 generates a corresponding function signal to control the actuating means 122. The actuating means 122 is utilized to perform the functions of the controlled electronic device 12. For example, the electronic device 12 may be a lamp or a fan, in which the actuating means 122 would perform the functions of the electronic device 12. For example, when the electronic device 12 is a lamp or a fan, the actuating means 122 may be the lamp driver or the motor of the fan. It is worth mentioning that the power plug 127 is for connecting to a power source (e.g., the city power supply), The control unit 123 usually has a demodulator circuit 1231, a logical circuit 1232 (e.g., a MCU shown in FIG. 1) and a memory unit 1233. The demodulator circuit 1231 connected to the IR receiver 126 demodulates the IR control signal from the dedicated remote control 11, and the demodulated result is transmitted to the control unit 1232. The logical circuit 1232 executes a function process according to the demodulated result, wherein the logical circuit 1232 may read the memory unit 1233 to perform the corresponding functions.

However, each electronic device usually has its dedicated remote control; therefore many remote controls could exist in each family for everyday life. The user needs to utilize the dedicated remote control to control the corresponding electronic device, which is not convenient for the user. Furthermore, the manufactures of the electronic devices need to design the dedicated remote controls corresponding to their electronic products, and the related cost of the remote controls may not be saved.

### SUMMARY OF THE INVENTION

The object of the instant disclosure is to offer a remotely controllable electronic device which could be remotely controlled by any infrared remote controller.

In order to achieve the aforementioned objects, according to an embodiment of the instant disclosure, a remotely controllable electronic device is provided. The remotely controllable electronic device comprises an infrared receiver, a control unit and a keypad unit. The infrared receiver is for wirelessly receiving a plurality of control signals. The control unit is coupled to the infrared receiver and generates a plurality of function signals. Each function signal is corresponding to one of the control signals received by the infrared receiver. The keypad unit is coupled to the control unit. The keypad unit has a learning mode key. The learning mode key is for making the remotely controllable electronic device operate in a learning mode.

In summary, the remotely controllable electronic device could start the learning mode when the learning mode key of the remotely controllable electronic device is pressed. After the learning process being executed in the learning mode, the remotely controllable electronic device could be control by the control signals of any infrared remote control. Thus, the user could use any infrared remote control to control the remotely controllable electronic device, and the related cost of the dedicated remote control of the electronic device could be saved accordingly.

In order to further the understanding regarding the instant disclosure, the following embodiments are provided along with illustrations to facilitate the disclosure of the instant disclosure.

### BRIEF DESCRIPTION OF THE DRAWINGS

FIG. 1 shows a block diagram of a conventional remote control system;

FIG. 2 shows a block diagram of a remote control system according to an embodiment of the instant disclosure;

FIG. 3 shows the correspondences between the functions of the electronic device and the learned IR control signals according to an embodiment of the instant disclosure;

FIG. 4 shows a block diagram of a remote controllable device according to an embodiment of the instant disclosure; and

FIG. 5 shows a flow chart of a remote controllable device according to an embodiment of the instant disclosure.

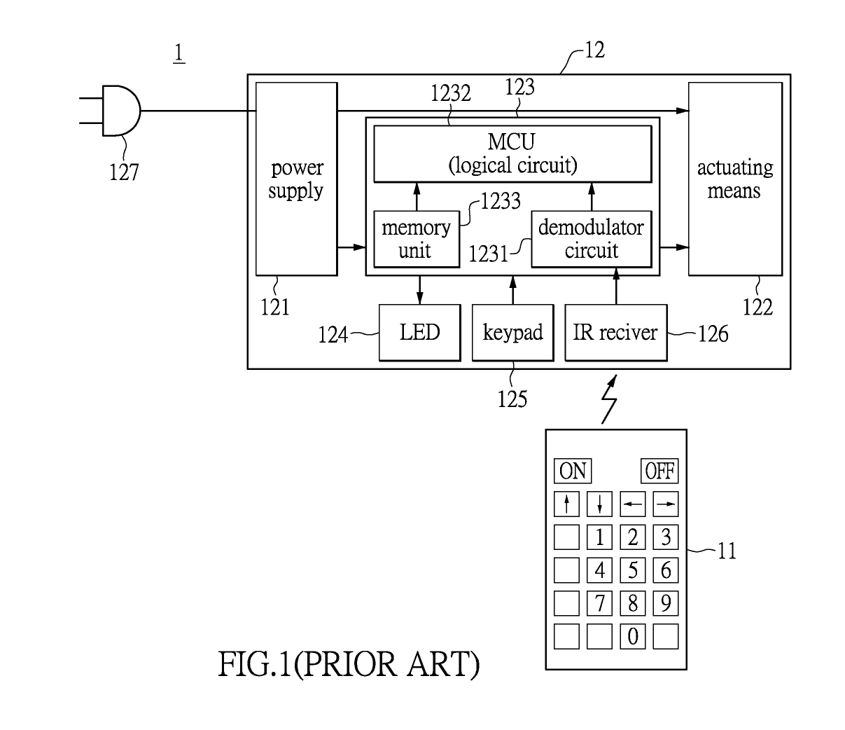

### DETAILED DESCRIPTION OF THE PREFERRED EMBODIMENTS

The aforementioned illustrations and following detailed descriptions are exemplary for the purpose of further explaining the scope of the instant disclosure. Other objectives and advantages related to the instant disclosure will be illustrated in the subsequent descriptions and appended drawings.

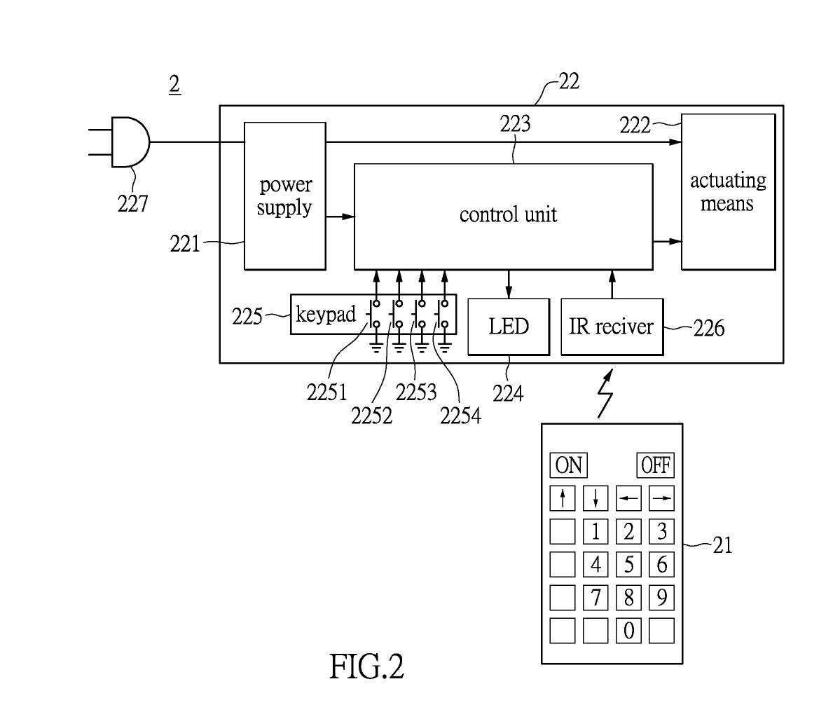

Please refer to FIG. 2 showing a block diagram of a remote control system according to an embodiment of the instant disclosure. A remote control system 2 comprises a remote control 21 and a remotely controllable electronic device 22. Differing from the conventional dedicated remote control 11 disclosed in the related art, the remote control 21 may be any IR remote control for any brand of home appliance. The remotely controllable electronic device 22 could enter a learning mode to learn the IR controls signals of any IR remote control 21. Specifically, the remotely controllable electronic device 22 comprises a power supply 221, an actuating means 222, an infrared (IR) receiver 226, a control unit 223, a status indicating unit 224, a keypad 225 and a power plug 227. The infrared receiver 226 is for wirelessly receiving a plurality of control signals from the remote control 21. The control unit 223 may be a microprocessor or a logical circuit constituted of several logic gates and related circuit.

The power supply 221 is connected to the power source through the power plug 227. The power supply 221 may be an AC-DC converter. The control unit 223 is coupled to the infrared receiver 226, the power supply 221, the status indicating unit 224, the keypad 225 and the actuating means 222. The power supply 221 provides electricity to the control unit 223 and the actuating means 222. The remotely controllable electronic device 22 may be a lamp, a fan, a stereo set, a washing machine or an oven. The keypad 225 may control the functions of the remotely controllable electronic device 22. The keypad 225 is coupled to the control unit. The keypad unit 225 has a learning mode key and at least a functional key. For ease of explanation, FIG. 2 shows a learning mode key 2251, a power on/off key 2252, a speed-up key 2253 and a slow-down key 2254, but the instant disclosure is not so restricted. The learning mode key 2251 is for making the remotely controllable electronic device operate 22 in a learning mode when the learning mode key 2251 is pressed by the user. For example, the learning mode key 2251 is for generating a learning mode signal to the control unit 223 when the learning mode key 2251 is pressed. When the control unit 223 receives the learning mode signal, the remotely controllable electronic device 22 would operate in the learning mode. The keypad unit 225 may only has the learning mode key 2251 only corresponding to the learning mode function. For example, the learning mode key is a predetermined specific key (which is distinguished from any other functional key(s) for the function(s) of the electronic device) of the electronic device. In another embodiment, the learning mode key 2251 may be designed as any one key on the electronic device 22 which controls at least one function of the electronic device 22. For example, when the remotely controllable electronic device 22 is a ceiling light having only one “ON/OFF switching” key, and the “ON/OFF switching” key could be the learning mode key of the ceiling light, in which the ceiling light could store any control signal from any remote control (e.g. the remote control 21) for configuring as the ON/OFF control signal of the ceiling light after the ON/OFF switching key is pressed (for triggering the learning mode).

The control unit 223 generates a plurality of function signals to control the actuating means 222. Each function signal is corresponding to one of the control signals received by the infrared receiver 226. Each key of the keypad 225 is corresponding to one function of the remotely controllable electronic device 22 (hereinafter referred to as electronic device 22), for example the learning mode key may be the power on/off key of the remotely controllable electronic device. However the keys of the keypad may be multi-functional keys. In one embodiment, the learning mode key may be designed as the power on/off key 2252, the speed-up key 2253 or the slow-down key 2254, in which function of the learning mode key may be replaced by pressing the power on/off key 2252 for a predetermined period (e.g., 3 seconds), or pressing the power on/off key 2252, the speed-up key 2253 or the slow-down key 2254 at the same time. In other words, the learning mode 2251 may be designed as any multi-functional key of the electronic device 22.

FIG. 4 shows a block diagram of a remote controllable device according to an embodiment of the instant disclosure. The control unit 223 comprises a demodulator circuit 2231, a decoder circuit 2234, a memory unit 2233 and a logical circuit 2232 (e.g., the MCU shown in FIG. 4). The demodulator circuit 2231 is coupled to the infrared receiver 226 for demodulating the plurality of control signals received by the infrared receiver 226. The decoder circuit 2234 is coupled to the demodulator circuit for receiving the demodulated control signals in order to decode the control signals. Because the remote control 21 may be any remote control dedicated to any home appliance made by any manufacturer, the decoder circuit 2234 may decode the demodulated control signal according to the IR protocol such as NEC, Philips, RC5, RC6, RC-MM, Toshiba, . . . etc. Compared to the conventional control unit 123, the control unit 223 of the present disclosure could decodes a plurality of IR protocols applied to the remote control 21, which means the remote control 21 may be changed. When the remote control 21 is changed to another remote control, the user only have to perform the learning mode again for dedicating the remote control 21 to the electronic device 22. In other words, any remote control 21 could be the dedicated remote control of the electronic device 22. The manufacturer of the electronic device 22 does not need to manufacture any dedicated remote control for the electronic device 22. Any IR remote control of any other electronic device could be the dedicated remote control of the electronic device 22 when the decoder circuit 2234 could be applied to decode the IR remote control of any other electronic device. For example, one remote control of the television made by the manufacturer Al or another remote control of the lamp made by the manufacturer B2 could be applied to control the electronic device 22 (e.g., a stereo set), as long as the decoder circuit 2234 could decode the IR protocols used by the manufacturers A1 and B2.

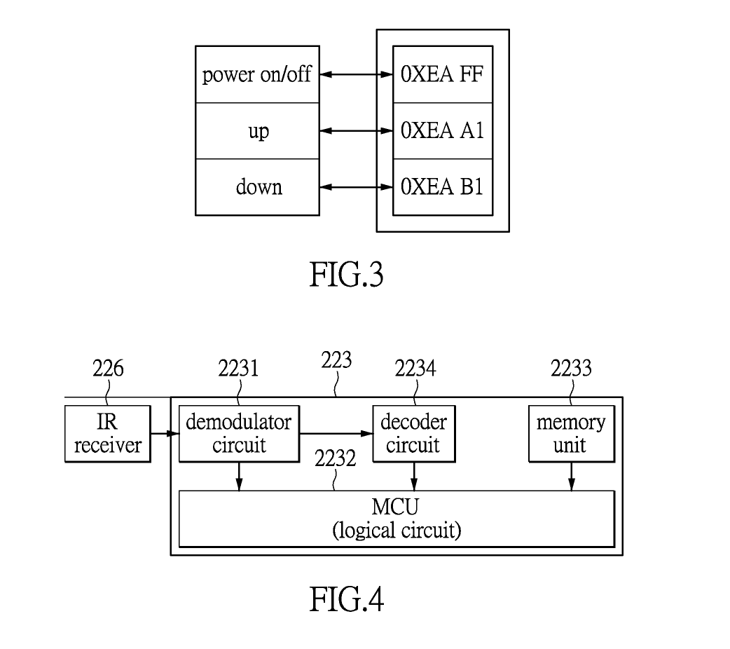

The memory unit 223 stores the learning result made by the logical circuit 2232. In detail, the memory unit 2233 may stores a look up table which records the correspondence between the received IR signals and the functions. FIG. 3 shows the correspondences between the functions of the electronic device and the learned IR control signals according to an embodiment of the instant disclosure. In this embodiment, the electronic device 22 has three default functions including power on/off, speed-up and slow-down. The code “OXEA FF” is correspondence to the function of power on/off. The code “OXEA A1” is correspondence to the function of speed-up. The code “OXEA A2” is correspondence to the function of slowdown.

The logical circuit 2232 is coupled to the decoder circuit and the memory unit for storing the decoded control signals to the memory unit 2233 when the remotely controllable electronic device 2 operates in the learning mode (e.g. the logical circuit 2232 receives the learning mode signal from the learning mode key 2251). The logical circuit 2232 itself may be a microprocessor or a logical circuit made by several logic gates, the present disclosure does not limit the implementation manner of the logical circuit 2232.

In the learning mode, the control unit 223 may sequentially memorize the received and decoded IR control signal to the memory unit 2233 of the control unit 223. For example, if the electronic device 22 is a fan which has the functions of power on/off, speed-up and slow-down, the user needs to use the remote control 21 to turn on/off the fan and switch the speed of the fan. A first button of the remote control 21 shall be defined as the power button of the fan, a second button of the remote control 21 may be defined as the speed-up button, and a third button of the remote control 21 may be defined as the slow-down button. The control unit 223 of electronic device 22 may be designed to memorize the first received IR control signal as the power on/off function, the second received IR control signal as the speed-up function and a third received IR control signal as the slow-down function in the learning mode. When the learning mode is started the status indicating unit 224 (i.e. LED) could display a preset light, such as a flashing red light. Then, the user could press the first button of the remote control 21 to send the first IR control signal, and the control unit 223 memorizes the received first IR control signal as the power on/off function. And, the user may further press the second button of the remote control 21 to send the second IR control signal for memorizing the second IR control signal as the speed-up function by the control unit 223. Then, the user may further press the third button of the remote control 21 to send the third IR control signal for memorizing the third IR control signal as the slow-down function by the control unit 223. After the control unit 223 sequentially memorized the received IR signals, the pressed buttons of the remote control 21 in the learning mode have been defined as the corresponding functions of the electronic device 22. The remote control 21 has already been the dedicated remote control of the electronic device 22. In practical applications, the user could use a remote control of other home appliance to control the electronic device 22, in which the user could define the rare used buttons of the remote control to control the electronic device 22. However, the user may define any button of the remote control 21 according to personal habits.

Additionally, the memory unit 2233 may memorize more than one set of the IR control signals. The memory unit 2233 may memorize the IR control signals of a remote control X1 in a learning mode. Then, another user may start the learning mode again and use a remote control X2 to send another set of IR control signals to the electronic device 22. Two or more remote controls could be dedicated to control the electronic device 22.

Furthermore, the electronic device 22 operates in a normal mode when the remotely controllable electronic device 2 does not operate in the learning mode (i.e. the control unit 223 does not receive the learning mode signal), and the logical circuit 2232 generates one of the function signals corresponding to the decoded IR control signal stored in the memory unit 2233 when the electronic device 22 receives the corresponding control signal in the normal mode. More specifically, in the normal operation, when the electronic device 22 receives the IR control signal, the decoder circuit 2234 decodes the IR control signal then logical circuit 2232 determines whether the received IR control signal is the learned control signal in the learning mode. If the received IR control signal is the learned control signal the control unit 223 controls the actuating means 222 to perform the corresponding function, such as altering the speed of the fan, or turning on/off the electronic device 22.

Alternatively, in one embodiment, the learning mode may be executed in the following process. When the learning mode signal is generated and the functional key is pressed then the logical circuit 2232 waits to receive and store the control signal coming from the remote control 21 to the memory unit 2233. The received and stored control signal after the functional key being pressed is corresponding to the function of the functional key. More specifically, in the learning mode, when a functional key of the electronic device 22 is pressed the logical circuit 2232 waits to receive and store a IR control signal for corresponding to the functional key, in which the user press a first button to generate the IR control signal. Then, if the user needs to make the correspondence of a second function of a second functional key (e.g., speed-up key) and a second button of the remote control 21, the user could press the second functional key of the electronic device 22 then press a second button of the remote control 21 to generate a second IR control signal. Accordingly, a number of buttons of the remote control 21 could be defined as the functional keys of the electronic device 22 for remotely control.

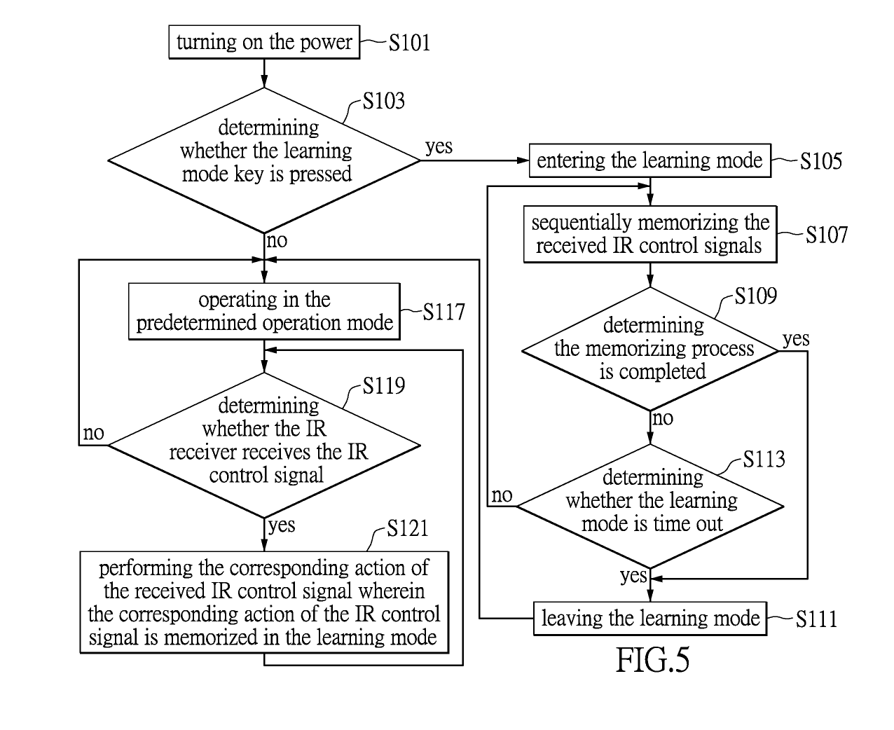

Please refer to FIG. 2 in conjunction with FIG. 5, FIG. 5 shows a flow chart of a remote controllable device according to an embodiment of the instant disclosure. First, in step S101, turning on the power. The user may connect the power plug or turn on the power switch of the electronic device 22. Then, in step S103, the control unit 223 determines whether the learning mode key 2251 is pressed or not (i.e. whether the learning mode signal is generated or not). If the learning mode key is pressed, then go to step S105, otherwise go to step S117. In step S105, the electronic device 22 enters the learning mode. Then, in step S107, the control unit 223 sequentially memorizes the received IR control signals. Then, in step S109, the control unit 223 determines the memorizing process is completed or not. If the memorizing process is completed, go to step S111, otherwise go to step S113. In step S111, leaving the learning mode. In step S113 determining whether the learning mode is time out or not. If the learning mode is time out, go to step S111, otherwise go to step S107 again. In step S111, leaving the learning mode. If the learning mode key is not pressed, then step S117 is executed to operate the predetermined operation mode which is the normal operation of the electronic devices 22. Then, in step S119, the control unit 223 determines whether the IR receiver 226 receives the IR control signal. If the IR control signal is received, then performs step S121, otherwise performs step S117 continually (i.e., step S117 is continually executed). In step S121, the electronic device 22 performs the corresponding action of the received IR control signal wherein the corresponding action of the IR control signal is memorized in the learning mode in advance. The flow chart of the operation of the electronic device 22 is only for describing the operation of the electronic device 22 in an understandable and clear way, but the present invention is not so restricted.

According to above descriptions, this instant disclosure provides an easy way to make the remotely controllable electronic device start the learning mode. The remotely controllable electronic device could start the learning mode after detecting that the learning mode key is pressed. After the learning process executed in the learning mode, the remotely controllable electronic device could be control by the control signals of any infrared remote control. Thus, the user could use any infrared remote control to control the remotely controllable electronic device, and the related cost of the dedicated remote control of the electronic device could be saved accordingly.

The descriptions illustrated supra set forth simply the preferred embodiments of the instant disclosure; however, the characteristics of the instant disclosure are by no means restricted thereto. All changes, alternations, or modifications conveniently considered by those skilled in the art are deemed to be encompassed within the scope of the instant disclosure delineated by the following claims.

What is claimed is:

1. A remotely controllable electronic device, comprising:
an infrared receiver, for wirelessly receiving a plurality of control signals;
a control unit, coupled to the infrared receiver, generating a plurality of function signals, wherein each function signal is corresponding to one of the control signals received by the infrared receiver; and
a keypad unit, coupled to the control unit, having a learning mode key, wherein the learning mode key is for making the remotely controllable electronic device operate in a learning mode.

2. The remotely controllable electronic device according to claim 1, wherein the control unit comprises:
a demodulator circuit, coupled to the infrared receiver, demodulating the plurality of control signals received by the infrared receiver;
a decoder circuit, coupled to the demodulator circuit, receiving the demodulated control signals to decode the control signals;
a memory unit; and
a logical circuit, coupled to the decoder circuit and the memory unit, storing the decoded control signals to the memory unit when the remotely controllable electronic device operates in the learning mode.

3. The remotely controllable electronic device according to claim 2, wherein when the remotely controllable electronic device operates in a normal mode, the logical circuit generates one of the function signals corresponding to the decoded control signal stored in the memory unit when the remotely controllable electronic device receives the corresponding control signal in the normal mode.

4. The remotely controllable electronic device according to claim 2, wherein when the remotely controllable electronic device operates in the learning mode and a functional key of the keypad unit is pressed then the logical circuit waits to receive and store the control signal coming from a remote control to the memory unit, wherein the received and stored control signal after the functional key being pressed is corresponding to the function of the functional key.

5. The remotely controllable electronic device according to claim 1, wherein the control unit is a microprocessor.

6. The remotely controllable electronic device according to claim 1, wherein the logical circuit is a microprocessor.

7. The remotely controllable electronic device according to claim 1, wherein the learning mode key is the power on/off key of the remotely controllable electronic device.

8. The remotely controllable electronic device according to claim 1, further comprises a power supply connected to the power source, the power supply is coupled to the control unit.

9. The remotely controllable electronic device according to claim 1, further comprises a status indicating unit.

10. The remotely controllable electronic device according to claim 1, wherein the learning mode key is a multi-functional key.

11. The remotely controllable electronic device according to claim 1, wherein the remotely controllable electronic device is a home appliance.

12. The remotely controllable electronic device according to claim 11, wherein the remotely controllable electronic device is a lamp, a fan, a washing machine or an oven.
